(19) United States
(12) Patent Application Publication
(10) Pub. No.: US 2016/0099674 A1
(43) Pub. Date: Apr. 7, 2016

(54) Flat Panel Photovoltaic System

(71) Applicant: Sharp Laboratories of America (SLA), Inc., Camas, WA (US)

(72) Inventors: Wei Pan, Vancouver, WA (US); Douglas Tweet, Camas, WA (US); Brian Wheelwright, Tucson, AZ (US); Gregory Stecker, Vancouver, WA (US); David Evans, Beaverton, OR (US); Hao-Chih Yuan, Vancouver, WA (US)

(21) Appl. No.: 14/825,240

(22) Filed: Aug. 13, 2015

Related U.S. Application Data
(63) Continuation-in-part of application No. 14/577,842, filed on Dec. 19, 2014.
Application No. 14/577,842 is a continuation-in-part of application No. 14/503,822, filed on Oct. 1, 2014.

(51) Int. Cl. H02S 40/22

(52) U.S. Cl. CPC H02S 40/22

(57) ABSTRACT

A flat panel photovoltaic (PV) system is provided formed from a first sheet with rows of concentrated III-V photovoltaic (CPV) solar cells. An overlying second sheet is made up of rows of waveguides, where each waveguide is coupled to a corresponding CPV solar cell. A third sheet includes overlying one-piece linear lenses, each having a focal line coupled to the waveguides in a corresponding row. Optionally, a fourth sheet underlies the first sheet, which is a 1-sun solar panel including a plurality of silicon PV cells. In one variation adjacent rows of waveguides couple to the same row of CPV cells. In another variation, each waveguide in a row is optically coupled to waveguides in an adjacent row, which adjacent waveguides are then coupled to a corresponding row of CPV cells. A lens overlies each row of waveguides, with a focal line coupled to each waveguide in that row.

### RELATED APPLICATIONS

The application is a Continuation-in-part of an application entitled, SOLAR CONCENTRATOR WITH ASYMMETRIC TRACKING-INTEGRATED OPTICS, invented by Wheelwright et al., Ser. No. 14/577,842, filed Dec. 19, 2014, Attorney Docket No. SLA3462;

which is a Continuation-in-part of an application entitled, HYBRID TROUGH SOLAR POWER SYSTEM USING PHOTOVOLTAIC TWO-STAGE LIGHT CONCENTRATION, invented by Wheelwright et al., Ser. No. 14/503,822, filed Oct. 1, 2014, Attorney Docket No. SLA3454. Both applications are incorporated herein by reference.

### BACKGROUND OF THE INVENTION

1. Field of the Invention

This invention generally relates to solar generated power and, more particularly, to an easily fabricated flat panel system that combines the advantages of silicon photovoltaic cells with concentrated (Group III-V) photovoltaic solar cells.

2. Description of the Related Art

The solar photovoltaic (PV) industry is dominated by conventional, “1-sun” silicon PV cells. The most efficient are made of single crystalline silicon (c-Si), with the highest performing cells at the time of this writing of around 25% efficient, and best panels at about 21% (e.g., SunPower@). However, the fundamental thermodynamic limit for Si is 29%. In contrast, concentrated III-V solar cells (CPV) have demonstrated record cell efficiencies of 46%, still far below their thermodynamic limits. However, “1-sun” c-Si PV can capture both direct and diffuse sunlight, while CPV requires high optical concentrations of 400-1000× (due to the high cost of the III-V cells), and so collect only direct sunlight. Furthermore, CPV systems require accurate two-axis tracking to continually point their optics towards the sun. CPV module efficiencies of 35% or more have been achieved (e.g., Semprius), but are only applicable to areas with very high direct sunlight.

FIG. 1 is a graph showing the percentage of annual diffuse radiation (prior art). The diffuse radiation varies from 20-25% in the southwestern US to a high of about 40% in the North East, Upper Midwest, and Pacific Northwest. As a result, CPV system deployment has been limited mostly to the areas of California, Arizona, Nevada, and New Mexico. At present, CPV systems represent less than 1% of the solar power market.

If, for example, a 30% efficient CPV system is deployed in a geographic area with a higher diffuse component, say 40%, only 0.3×(1−0.4)=18% of the total sunlight is collected. This is less than a cheaper c-Si system that can collect 21% of the sunlight, both direct and diffuse. Furthermore, on a partly-cloudy day the power generation of the CPV system would go from maximum to almost nothing in a few seconds when a cloud crosses the sun, putting strain on the electrical grid. If diffuse sunlight could also be collected, the decrease would be much less. Furthermore, the optical systems and 2-axis trackers for CPV systems have tended to be very large and bulky, requiring expensive, massive support structures, further limiting their market potential.

There is a need for CPV systems that can collect both direct and diffuse light, to enable greater than 30% total efficiency in geographic areas and markets with more than 25% diffuse sunlight. There is a need for compact and light systems, to reduce mechanical constraints and balance of system (BOS) costs, and to expand into more potential markets.

There have been a wide variety of systems devised to make CPV more compact, but few which enable collection of both direct and diffuse sunlight. One approach uses lenslet arrays to couple light into a waveguide, with CPV cells mounted on the side of the waveguide. However, for most of these systems it is difficult to also incorporate the collection of diffuse sunlight. A recent review of tracking-integrated schemes is given in Reference [1]. Some of the approaches described in this reference include lenslet arrays and planar lightguides with lateral motion. Much of the analysis discussed below is from Reference [1].

FIG. 2 illustrates the use of a 2D array of lenslets to illuminate a planar lightguide that has multiple small prismatic reflectors to couple focused light into the waveguide (prior art). The light is conducted down the waveguide by total internal reflection (TIR). The figure depicts the use of a 2D array of lenslets to illuminate a planar waveguide and collection by CPV cells at the edge of the waveguide [2]. Since the reflective couplers take up a small fraction of the waveguide surface, decoupling losses are anticipated to be small. However, this system requires external two-axis tracking. By laterally translating the lightguide relative to the lenslet array, it is possible to achieve effective two-axis tracking over a limited angular range [3]. The use of two moveable lenslet arrays increases the angular range, but at the expense of increased panel thickness [4, 5].

There exist a number of other designs for coupling of light focused by a lenslet array into a planar waveguide. These use a light-induced material property change to passively track the sun over a limited angular range [6-11].

FIG. 3 is a schematic depicting a hybrid CPV/PV architecture (prior art). Recently, there have been efforts to collect both direct and diffuse sunlight [12, 13]. These efforts involve integrating 2D arrays of lenslets which concentrate direct sunlight onto III-V CPV cells placed on a backplane made up of conventional cells like Si or thin-films. These latter cells collect the diffuse sunlight.

FIG. 4 is a graph depicting the simulated performance of a system similar to the one shown in FIG. 3 [12](prior art). The geometric concentration is 100×. At small incidence angles (within the acceptance angle of the lenslet array) the performance is dominated by the CPV cells. As incidence angles increase (e.g. due to misalignment or diffuse light), the performance is dominated by the Si cells. Without integration of the Si cells, the performance would go to nearly zero at these higher angles. Note that integrating the collection of both direct and diffuse light makes the overall system a little more tolerant to misalignment of the optics. However, one issue with any 2D array of lenses is the “dead space” between lenses, where the fabricated concave cusps are not sharp, reducing the optical efficiency of the concentrating system.

It would be advantageous if a hybrid solar system combining 1-sun silicon PV cells with CPV solar cells could be optimized for use with 2-axis tracking.

The following articles and patent applications are incorporated herein by reference:
[1] Wheelwright B. M., Angel R., and Coughenour B. M., “Tracking-Integrated Optics: Applications in Solar Concentration”, International Optical Design Conference (2014) and references therein.
[2] Karp, J. H., Tremblay, E. J., Ford, J. E. “Planar micro-optic solar concentrator”, Optics Express 18(2): 1122-33 (2010).
[3] Hallas J M, K A Baker, J H Karp, E J Tremblay, and J E Ford. 2012. “Two-axis solar tracking accomplished through small lateral translations”. Applied Optics. 51 (25): 6117-24.
[4] Duerr F, Y Meuret, and H Thienpont. 2011. “Tracking integration in concentrating photovoltaics using laterally moving optics”. Optics Express. 19: 207-18.
[5] Duerr, Fabian, Youri Meuret, and Hugo Thienpont. 2013. “Tailored free-form optics with movement to integrate tracking in concentrating photovoltaics”. Optics Express. 21 (S3): A401.
[6] Baker K A, J H Karp, E J Tremblay, J M Hallas, and J E Ford. 2012. “Reactive self-tracking solar concentrators: concept, design, and initial materials characterization”. Applied Optics. 51 (8): 1086-94.
[7] Zagolla V, E Tremblay, and C Moser. 2012. “Light induced fluidic waveguide coupling”, Optics Express. 20: 924-31.
[8] Tremblay E J, D Loterie, and C Moser. 2012. “Thermal phase change actuator for self-tracking solar concentration”. Optics Express. 20: 964-76.
[9] Zagolla, Volker, Eric Tremblay, and Christophe Moser. 2014. “Proof of principle demonstration of a self-tracking concentrator”. Optics Express. 22 (S2): A498.
[10] Schmaelzle, P; Whiting, G; Martini, J; Fork, D; Maeda, P. “Solar Energy Harvesting Device Using Stimuli-Responsive Material.” US2012/0132255. May 31, 2012.
[11] Kozodoy, P. “Light-Tracking Optical Device and Applications to Light Concentration.” U.S. Pat. No. 8,634,686. Jan. 21, 2014.
[12] Haney, M. W., Gu, T., and Agrawal., G “Hybrid Micro-scale CPV/OV Architecture” IEEE 40^{th} Photovoltaic Specialist Conference (PVSC-2014) pp 2122-2126.
[13] Haney, M. W., Gu, T., and Agrawal. G, U.S. 61/787,079, Mar. 15, 2013.
[14] Antonio L. Luque; Viacheslav M. Andreev, Concentrator Photovoltaics, 2007 Springer Verlag.

### SUMMARY OF THE INVENTION

Disclosed herein is the integration of high efficiency concentrating photovoltaic cells (CPV) with conventional 1-sun solar panels (thin film or c-Si) to capture both direct and diffuse sunlight, particularly, in low direct normal insolation (DNI) regions. In addition, a lower-cost version with no integrated 1-sun cells is disclosed that is more applicable to high DNI regions. An array of lenses captures and concentrates direct sunlight to a line focus and then couples it into a horizontal waveguide. The waveguide further concentrates direct sunlight onto high performance III-V CPV cells that are mounted on an underlying 1-sun panel, which collects diffuse sunlight. In one variation, the entire assembly is mounted on a 2-axis tracker for optimum collection of sunlight throughout the day and year. Initial optical analysis indicates that greater than 30% total efficiency can be achieved in a thin, flat form factor. Furthermore, mass production analogous to that of current liquid crystal display (LCD) panel fabrication can be expected to drive costs down, thus satisfying the overall objective of large-scale expansion of the market for an entirely new class of micro-scale CPV solar panels.

Advantageously, the system may use cylindric, acylindric, or Fresnel lenses instead of a 2D array of lenslets to minimize the loss or “dead space” where lenses meet. Unlike the conventional designs described in the Background Section, the CPV cells are mounted on a flat substrate instead of the edge of the waveguide, so they are much easier to manufacture. The entire design involves parallel sheets of: lenses, waveguides, and PV/CPV cells. The CPV cell array may be placed atop a 1-sun panel cell for monolithic integration and excellent heat dissipation. Diffuse sunlight is collected, as well as direct sunlight, as the waveguide only occupies a portion of the surface area, increasing the collection of diffuse light.

Accordingly, a flat panel photovoltaic (PV) system is provided formed from a first sheet with a first row of concentrated III-V photovoltaic solar cells, where each CPV solar cell has an optical input and an electrical output. A second sheet overlies the first sheet and is made up of a first row of waveguides. Each waveguide has an optical input and optical output aperture coupled to a corresponding CPV solar cell optical input. A third sheet includes a one-piece linear lens overlying the first row of waveguides, having a focal line coupled to the optical input aperture of each waveguide in the first row. In one aspect, a fourth sheet underlies the first sheet, which is a 1-sun solar panel including a plurality of silicon PV cells. Note: when silicon PV cells are used in the system, the CPV cells may be formed on top of the 1-sun solar panel, so that the entire system is made up of a 3-sheet stack. However, for greater clarity, this discussion assumes that the first and fourth sheets are separate.

The second sheet may also include a first mirror configured to redirect light from the focal line of the one-piece linear lens towards the optical output aperture of each waveguide in the first row of waveguides. Since the waveguides are transparent their optical input apertures may be formed in planar top surfaces, with the first mirror positioned at a (−α) degree angle with respect to the planar top surface, where (α) is in the range of 30 to 60 degrees. Typically, each waveguide has an optical output aperture formed in a planar bottom surface. A plurality of second mirrors is configured to redirect light from the first mirror to the waveguide optical output, and is positioned at an angle of (−λ) degrees with respect to the planar top surface, where λ is in a range of 30 to 60 degrees.

In one variation, the second sheet further includes a second row of waveguides, with each waveguide in the second row having an optical output aperture coupled to a corresponding CPV cell in the first row of CPV cells. That is, each CPV cell collects radiation from one waveguide in the first row of waveguides and one waveguide in the second row of waveguides. Then, a first one-piece linear lens overlies the first row of waveguides, a second one-piece linear lens overlies the second row of waveguides, and intersection of the first and second one-piece linear lenses overlies the first row of CPV cells. Typically, such a system is made up of a plurality of CPV solar cell rows. If the first row of waveguides and second row of waveguides are defined as a first waveguide assembly, then the second sheet further includes a plurality of waveguide assemblies, each waveguide assembly associated with a corresponding CPV solar cell row.

In another variation, the second sheet further includes a second row of waveguides, where each waveguide in the second row is adjacent to a corresponding waveguide in the first row of waveguides, with an optical output aperture coupled to an optical input aperture of the corresponding waveguide. Alternatively stated, the two waveguides can be considered a single waveguide of two sections with two optical input apertures and a single optical output aperture coupled to a corresponding CPV cell in the first row of CPV cells. Then, a one-piece linear lens overlies each corresponding row (section) of waveguides, with a focal line coupled to the optical input of each waveguide in the corresponding row of waveguides.

Additional details of the above-described system are presented below.

### BRIEF DESCRIPTION OF THE DRAWINGS

FIG. 1 is a graph showing the percentage of annual diffuse radiation (prior art).

FIG. 2 illustrates the use of a 2D array of lenslets to illuminate a planar lightguide that has multiple small prismatic reflectors to couple focused light into the waveguide (prior art).

FIG. 3 is a schematic depicting a hybrid CPV/PV architecture (prior art).

FIG. 4 is a graph depicting the simulated performance of a system similar to the one shown in FIG. 3 [12](prior art).

FIGS. 5A through 5c are partial cross-sectional views of a flat panel photovoltaic (PV) system.

FIG. 6 is a plan view of the systems of FIG. 5B or 5C.

FIG. 7 is a perspective view depicting features of the waveguide and one-piece linear lens.

FIG. 8A is a partial cross-sectional view depicting a first variation of the systems described in FIG. 5A through 5C, and FIG. 8B is waveguide detailed view.

FIG. 9 is a partial cross-sectional view depicting a second variation of the systems described in FIGS. 5A through 5C.

FIG. 10 is a partial cross-sectional view depicting the waveguides of FIG. 9 in greater detail.

FIG. 11 is a plan view depicting the first, second, and fourth sheets of the system depicting in FIG. 9.

FIG. 12 shows the calculated optical efficiency for geometric concentrations of 25, 50, and 100 as a function of skew angle.

FIGS. 13-15 depict the final diffuse loss (#8).

FIG. 16 is a graph illustrating the overall system efficiency as a function of CPV cell efficiency and diffuse light fraction.

FIG. 17 is a perspective view depicting a row of waveguides with a tapered width in the shape of a compound parabolic concentrator (CPC).

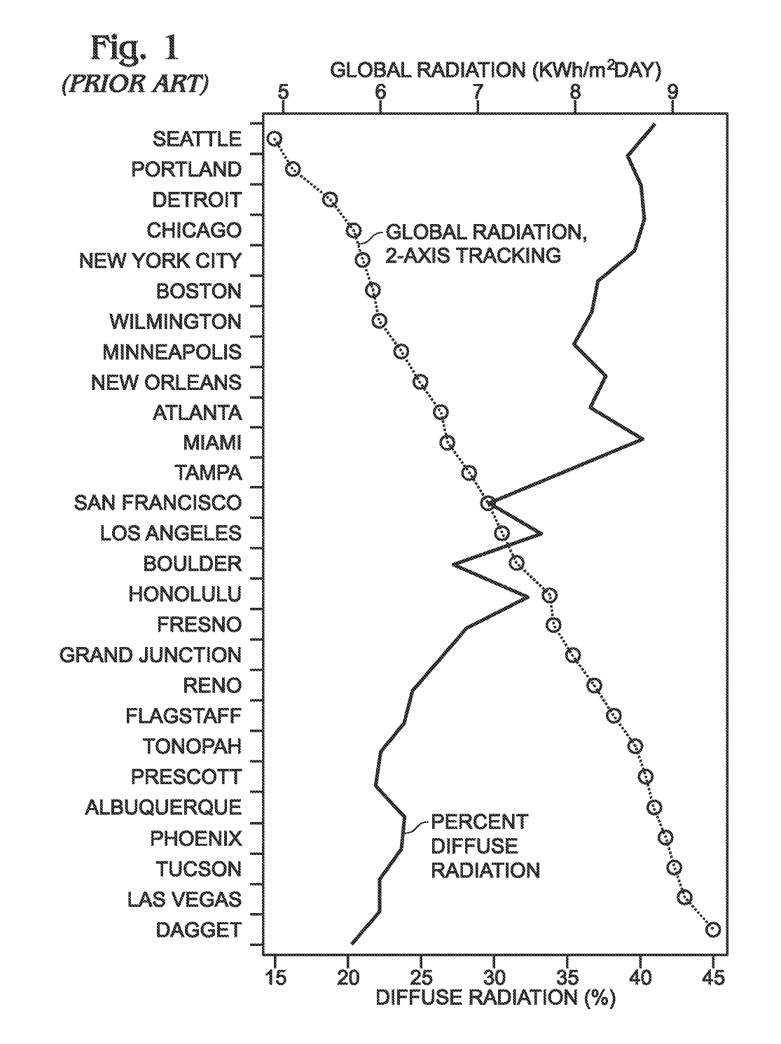

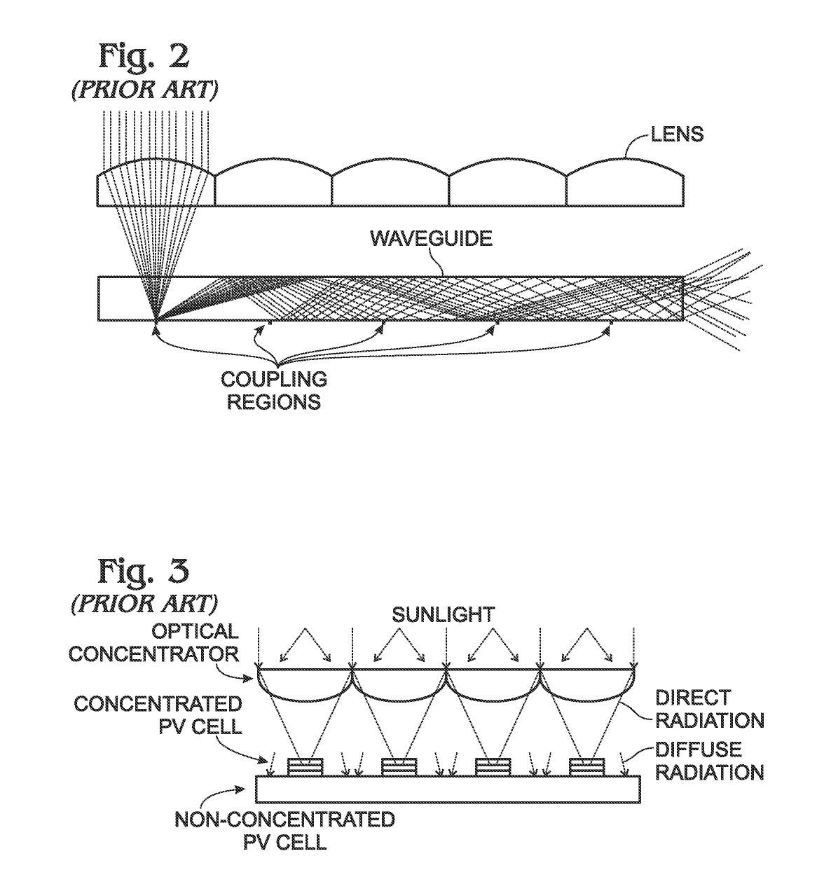

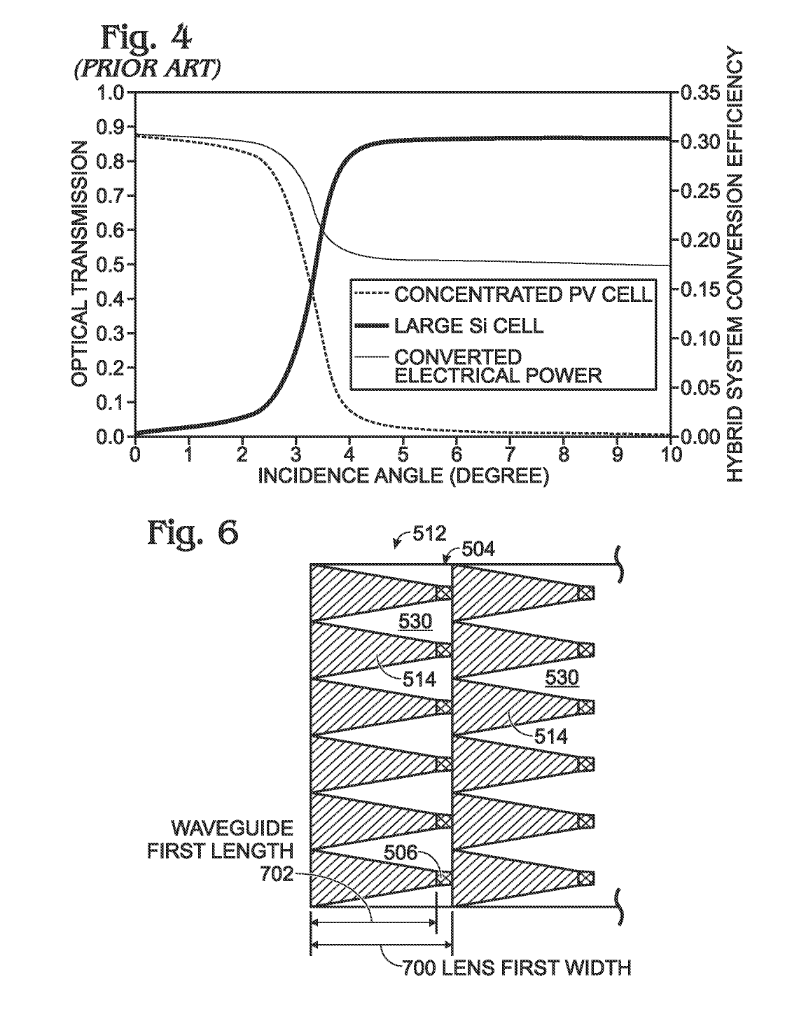

### DETAILED DESCRIPTION

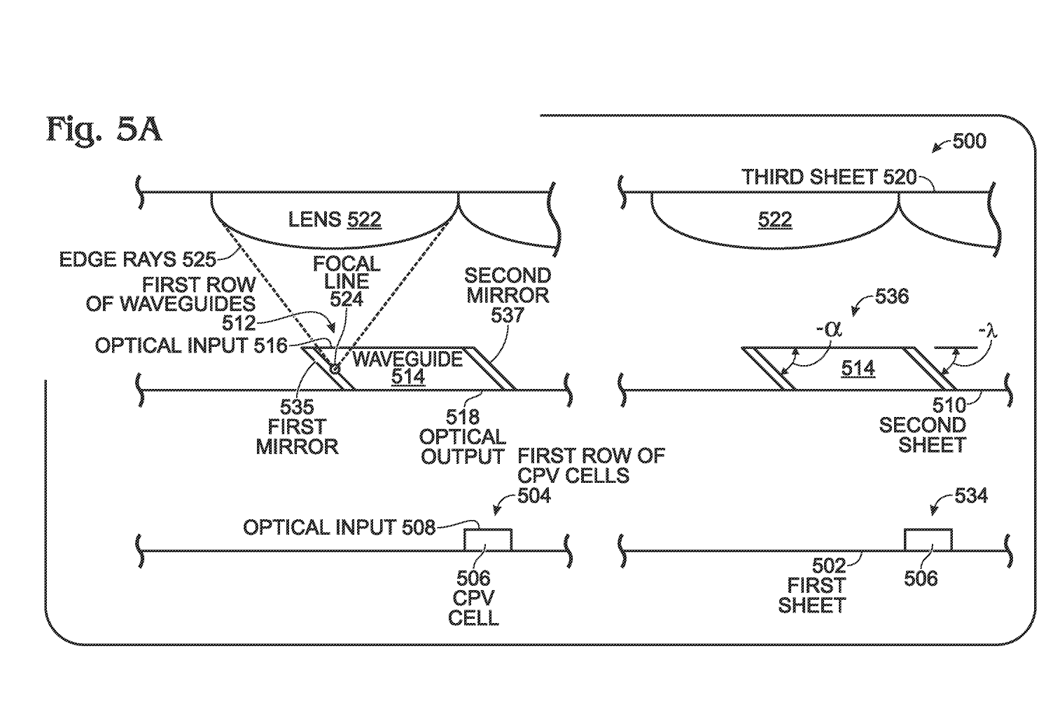

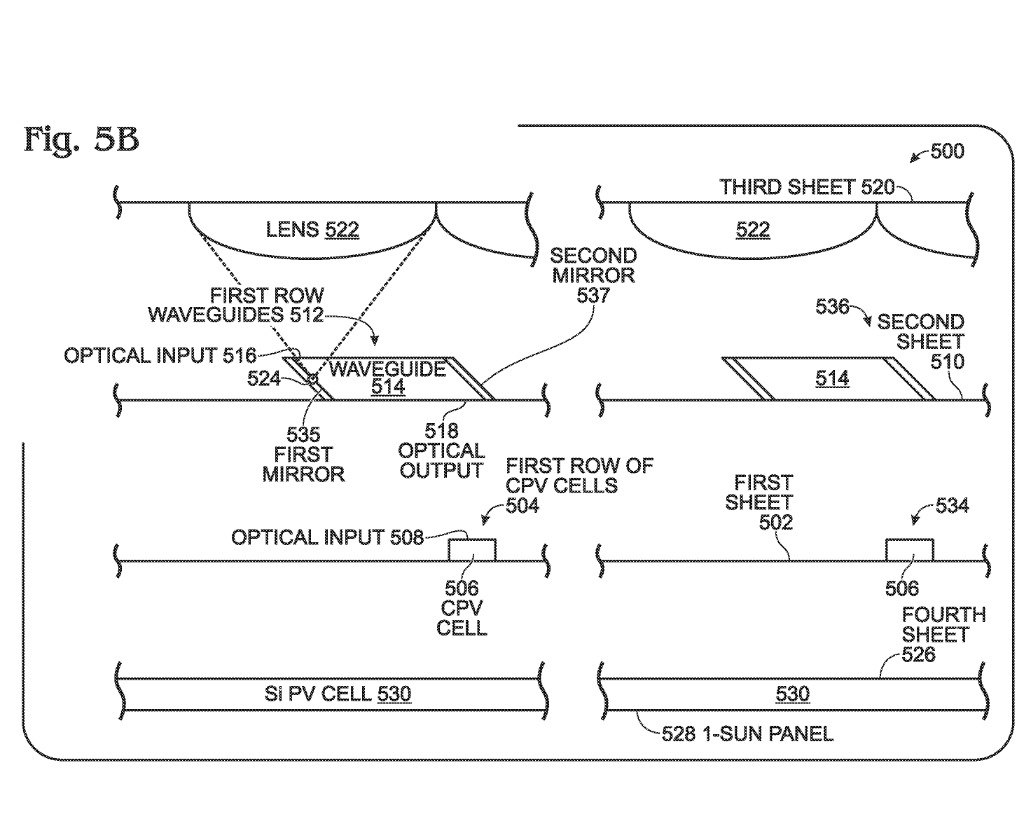

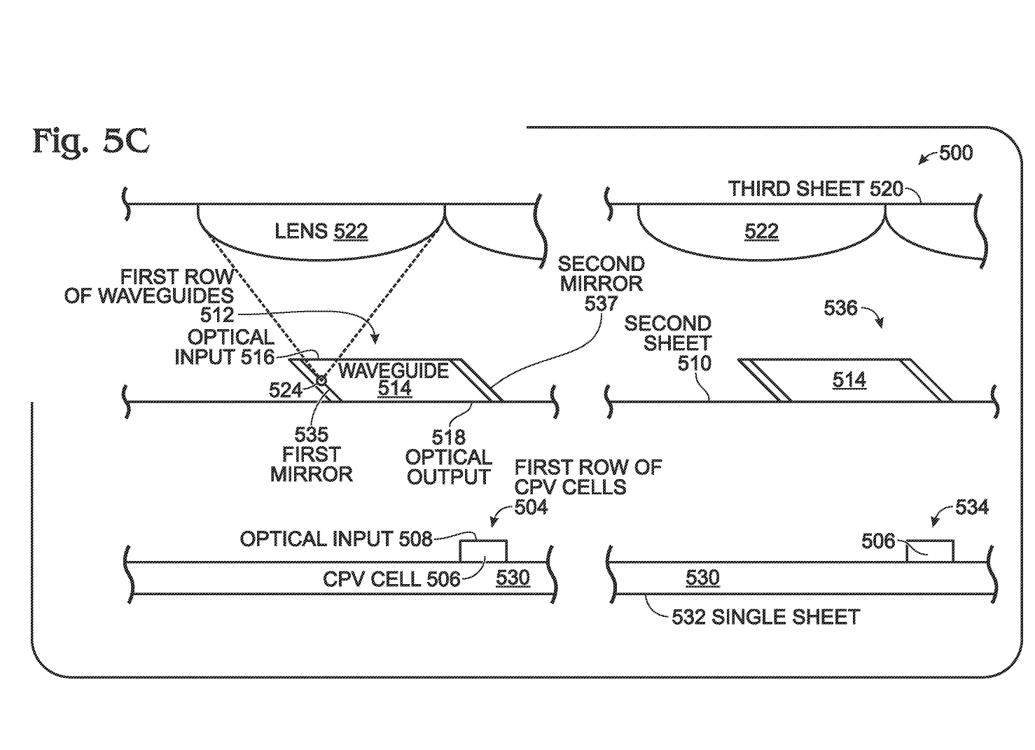

FIGS. 5A through 5c are partial cross-sectional views of a flat panel photovoltaic (PV) system. In FIG. 5A the system 500 comprises a first sheet 502 comprising a first row 504 of concentrated III-V photovoltaic (CPV) solar cells 506 (only one CPV cell can be seen in profile). Each CPV solar cell 506 has an optical input 508 and an electrical output (not shown, formed as a trace in first sheet 502). For example, the CPV cells may be GaAs-based or InGaN-based multijunction cells.

A second sheet 510 overlies the first sheet 502 and comprises a first row 512 of waveguides 514. Each waveguide 514 has an optical input 516, and optical output 518 coupled to a corresponding CPV solar cell optical input 508. A third sheet 520 overlies the second sheet 510 and comprises a one-piece linear lens 522 overlying the first row 512 of waveguides. A focal line 524 (shown as a “dot” coming out of the page) is coupled to the optical input 516 of each waveguide 514 in the first row. Edge rays 525 are shown for reference. Typically, the system 500 may comprise a plurality of CPV rows and a plurality of waveguide rows associated with a one-piece linear lens 522. Therefore, CPV row 534 and waveguide row 536 are also shown. The one-piece linear lens 522 may be cylindric, acylindric, or a Fresnel lens, with an f-number in the range of F/0.5 to F/5, where an f-number is the ratio of focal length to lens aperture (i.e., lens width). Typically, an acylindric lens would be associated with the lower range of f-numbers and a cylindric lens would be associated with the higher range. There is significantly less boundary region associated with a linear lens, as opposed to a lenslet array of many 2D lenses, which reduces the amount of “dead space” (undefined light propagation) between lenses.

Referring to FIG. 5A, although potentially applicable to FIGS. 5B and 5C, the second sheet layer 510 further comprises a first mirror 535 configured to redirect light from the focal line 524 of the one-piece linear lens 522 towards the optical output 518 of each waveguide 514 in the first row of waveguides 512. Typically, each waveguide 514 is transparent and has an optical input aperture 516 formed in a planar (horizontal) top surface. Since the optical input aperture is formed in the plane of the top surface, the planar top surface is not labeled. Then, the first mirror 535 is positioned at a (−α) degree angle with respect to the planar top surface, where (α) is in the range of 30 to 60 degrees. A single first mirror may be positioned across each waveguide 514 in the first row 512, or alternatively, each waveguide 514 may have its own unique first mirror. It is also typical that each waveguide 514 has an optical output aperture 518 positioned in a planar bottom surface of each waveguide. Then, the system 500 comprises a plurality of second mirrors 537 (only one second mirror is shown in profile). Each second mirror 537 is configured to redirect light through the output aperture 518 and is positioned at a (−λ) degree angle with respect to a corresponding waveguide in the first row of waveguides 512, where λ is in the range of 30 to 60 degrees with respect to the planar top surface. Here it is assumed that the planar top surface is in the same (horizontal) plane as the waveguide optical input 516. If it is not, λ may be adjusted to account for the offset.

In FIG. 5B the system 500 further comprises a fourth sheet 526 underlying the first sheet 502. The fourth sheet 526 comprising a 1-sun solar panel 528 including a plurality of silicon (Si) PV cells 530. FIG. 5C is similar to FIG. 5B, except that the CPV cells 506 are formed overlying the Si PV cells 530 as a single sheet 532. Typically, the Si PV cells are made from whole wafers with internal wiring. Besides Si, the PV cells may be made from CdTe, copper indium gallium (di)selenide (CIGS), or similar materials.

FIG. 6 is a plan view of the systems of FIG. 5B or 5C. Referencing just two rows, the plurality of silicon PV cells 530 occupy a first surface area (the entire area shown), the plurality of CPV solar cell rows occupy a second surface area (shown in double cross-hatch), and the plurality of waveguide rows on the second sheet occupy a third surface area (shown in cross-hatch). The first surface area is greater than the summation of the second and third surface areas, which permits the capture of diffuse radiation. Further, since the waveguides are transparent, diffuse light passing through the waveguides is also captured.

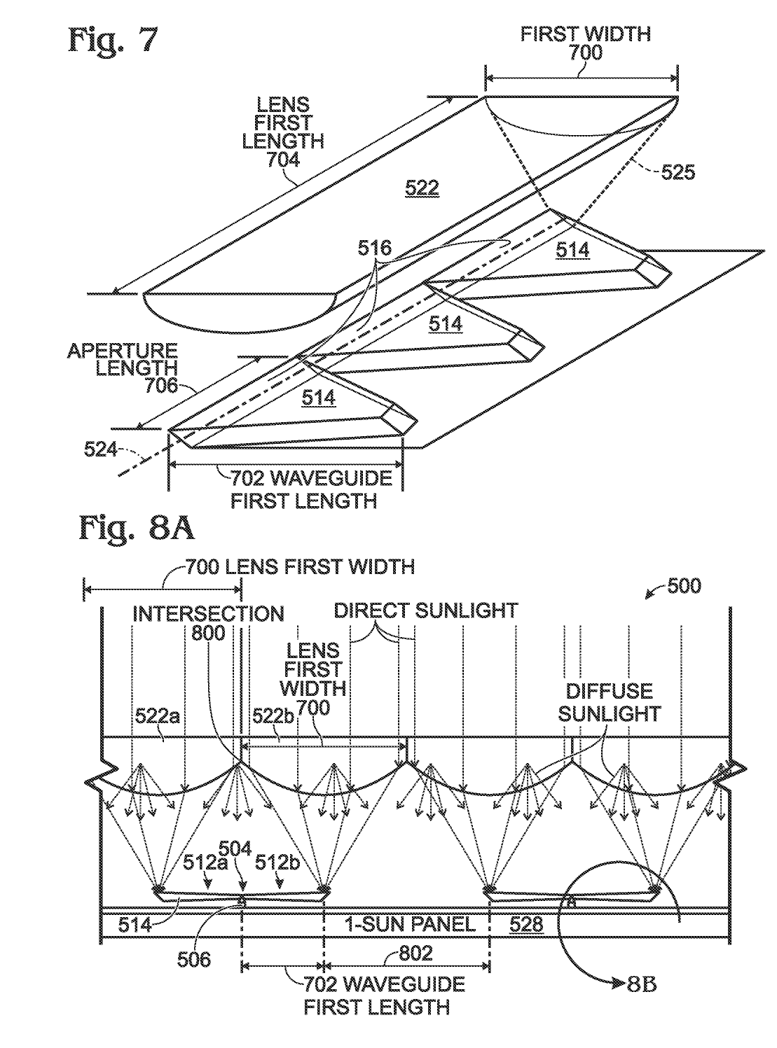

FIG. 7 is a perspective view depicting features of the waveguide and one-piece linear lens. To simplify the drawing, the sheets upon which the below-described components are mounted are not shown. It can be seen in this view that each waveguide 514 has a width tapered from the optical input aperture 516 to the optical output aperture. As shown, the taper may be straight edge, or as shown in several examples presented below, the taper may take the form of a compound parabolic concentrator (CPC) shape, see FIG. 17.

The third sheet comprises a plurality of adjacent one-piece linear lenses 522 (only one lens is shown for greater clarity). Each one-piece linear lens 522 has a first width 700. Adjacent rows of waveguides 514 in the second sheet are separated by a distance equal to the first width (see FIG. 6). Each waveguide 514 has a first length 702, between the optical input aperture 516 and the optical output aperture (not shown), less than the first width 700.

As can be seen in FIG. 7, the focal line 524 and the one-piece linear lens 522 have a lens first length 704. Each waveguide optical input aperture has a length 706 formed in the planar waveguide top surface, and the summation of waveguide optical input aperture lengths in the first row of waveguides 512 is equal to the lens first length 704. If the length 702 of the waveguide 514 changes, the width 700 of the lens 522 changes accordingly, but the general relationship between waveguide length and lens width stays the same. That is, if the waveguide length 702 gets shorter, the lens width 700 gets smaller.

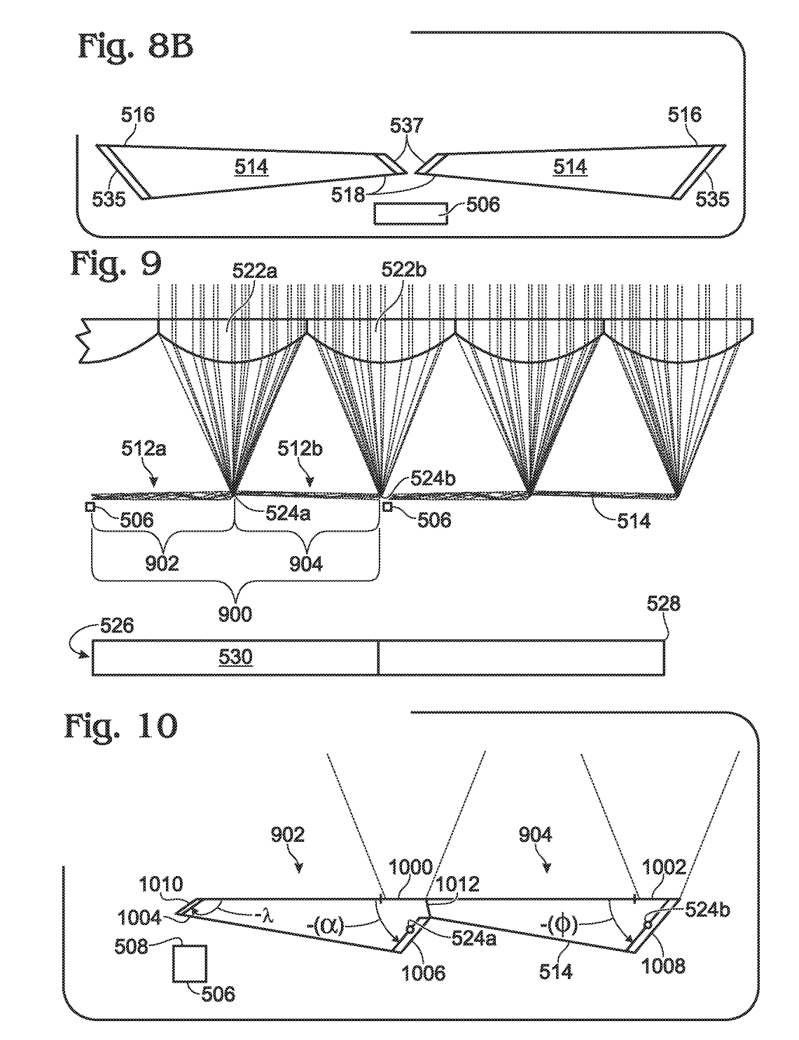

FIG. 8A is a partial cross-sectional view depicting a first variation of the systems described in FIG. 5A through 5C, and FIG. 8B is waveguide detailed view. To simplify the drawing, the sheets upon which the below-described components are mounted are not shown. In this aspect, the second sheet comprises a first row of waveguides 512a and a second row of waveguides 512b. Each waveguide 514 in the first row 512a has an optical output aperture coupled to a corresponding CPV cell 506 in the first row of CPV cells 504. Likewise, each waveguide 514 in the second row 512b has an optical output coupled to a corresponding CPV cell 506 in the first row of CPV cells 504. Alternatively stated, the optical outputs of corresponding waveguides 514 in the first and second row of waveguides 512a/512b are paired to couple to a corresponding CPV solar cell optical input. The waveguides 514 may have a plan view tapered shape as shown in FIGS. 6 and 7. As seen in FIG. 8B, the waveguides 514 may have a cross-sectional taper, narrowing from optical input 516 to optical output 518. Alternatively, as shown in FIG. 7 for example, the waveguides may have a uniform cross-section.

In the third sheet, a first one-piece linear lens 522a overlies the first row of waveguides 512a, a second one-piece linear lens 522b overlies the second row of waveguides 512b, and the intersection 800 of the first and second one-piece linear lenses 522a/522b overlies the first row of CPV cells 504. Note, although not explicitly shown, the system 500 of FIG. 8A can be fabricated without the 1-sun solar panel 528. If the 1-sun solar panel 528 is included, the Si PV cells and CPV cells may be formed on the same sheet as in FIG. 5C.

As shown, the system may comprise a plurality of CPV solar cell rows. If the first row of waveguides 512a and second row of waveguides 512b form a first waveguide assembly, then the second sheet further comprises a plurality of waveguide assemblies, each waveguide assembly associated with a corresponding CPV solar cell row. If the one-piece linear lens (e.g., 522a) has a lens first width 700, then adjacent waveguide assemblies in the second sheet are separated by a distance 802 equal to the first width 700. Further, each waveguide 514 has a waveguide first length 702, between the optical input and optical output (see FIGS. 6 and 7), equal to half the lens first width 700.

FIG. 9 is a partial cross-sectional view depicting a second variation of the systems described in FIGS. 5A through 5C. To simplify the drawing, the sheets upon which the below-described components are mounted are not shown. The second sheet comprises a first row of waveguides 512a and a second row of waveguides 512b. Each waveguide 514 in the second row of waveguides 512b is adjacent to a corresponding waveguide in the first row of waveguides 512a, and has an optical output aperture coupled to an optical input aperture of the corresponding waveguide (see FIG. 10 for details). The third sheet comprises a one-piece linear lens overlying each corresponding row of waveguides, with a focal line 524a and 524b coupled to the optical input aperture of each waveguide 514 in the corresponding row of waveguides, respectively, 512a and 512b.

Alternatively stated, the first and second rows of coupled waveguides 512a may be fabricated or conceptually considered as a first row of waveguides 900, where each waveguide has a first optical input aperture, a second optical input aperture, and an optical output aperture (see FIG. 10) coupled to a corresponding CPV cell 506. A first section 902 is between the first optical input and optical output and a second section 904 between the second optical input and the first optical input. In this alternative interpretation, a first one-piece linear lens 522a overlies the first section 902 and has a first focal line 524a coupled to the first optical input of each waveguide in the first row 900. A second one-piece linear lens 522b overlies the second section 904 and has a second focal line 524b coupled to the second optical input on each waveguide in the first row of waveguides. Optionally as shown, the system 500 may comprise a fourth sheet 526 comprising a 1-sun solar panel 528 including a plurality of silicon PV cells 530. Again, if this option is enabled, the CPV cells 506 may be mounted overlying and on the same substrate as the PV cells 530.

FIG. 10 is a partial cross-sectional view depicting the waveguides of FIG. 9 in greater detail. To simplify the drawing, the sheets upon which the below-described components are mounted are not shown. The following explanation describes the waveguide 514 as a single piece of two sections, but is equally applicable to the double-stacked or two waveguide assembly interpretation mentioned in the paragraph above. Typically, the waveguide 514 is transparent, so that the first optical input aperture 1000 and second optical input aperture 1002 can formed in a planar top surface of the waveguide. Note: top surfaces of sections 902 and 904 need not necessarily be in the same plane, although they are both substantially horizontal. The optical output aperture 1004 is positioned in the planar bottom surface of the waveguide. A first mirror 1006 is configured to redirect light from the first focal line 524a of the first one-piece linear lens towards the first optical output 1004 of each waveguide in the first row of waveguides, where the first mirror 1006 is positioned at a −(α) degree angle with respect to the planar top surface, where (α) is in a range of 30 to 60 degrees.

A second mirror 1008 is configured to redirect light from the second focal line 524b of the second one-piece linear lens towards the optical output 1004 of each waveguide in the first row of waveguides, via transparent section 1012. The second mirror is positioned at a −(Φ) degree angle with respect to the planar top surface, and where (Φ) is in a range of 30 to 60 degrees. Again it is assumed that the planar top surface and CPV optical input are in the same (horizontal) plane. If they are not, the angles described above may include an additional adjustment to account for any offset. As described above, the first and second mirrors 1006/1008 may be discrete pieces associated with each waveguide, or single pieces associated with an entire row of waveguides. A plurality of third mirrors 1010 may be associated with a row of waveguides (one is shown in profile). Each third mirror 1010 is positioned at a −(λ) degree angle and configured to redirect light through the waveguide optical output aperture 1004 to the CPV cell 506 optical input 508.

The system of FIGS. 9 and 10 can achieve a concentration of 700×. Rather than sending light from two adjacent lenses in opposite directions to one sensor (FIG. 8A), this design sends light from two adjacent lenses in the same direction, to one sensor (CPV cell). Light from one lens is coupled in with light from another lens and then concentrated to one CPV cell. There is a transparent section 1012 to allow the light to be combined. Rays focused from lens 522b come from above and are coupled into the waveguide (section 904) by a, e.g., 45 degree, silvered mirror 1008. These rays travel to the “left” inside the waveguide, and are angled to the top of the coupling section 1012 for entry into section 902. Light from lens 522a is focused onto a, e.g., 45 degree, silvered mirror 1006 and is sent to the left. Light from section 902 and section 904 is then sent down the waveguide to the left, where it is coupled down to a single CPV cell 506 via mirror 1010.

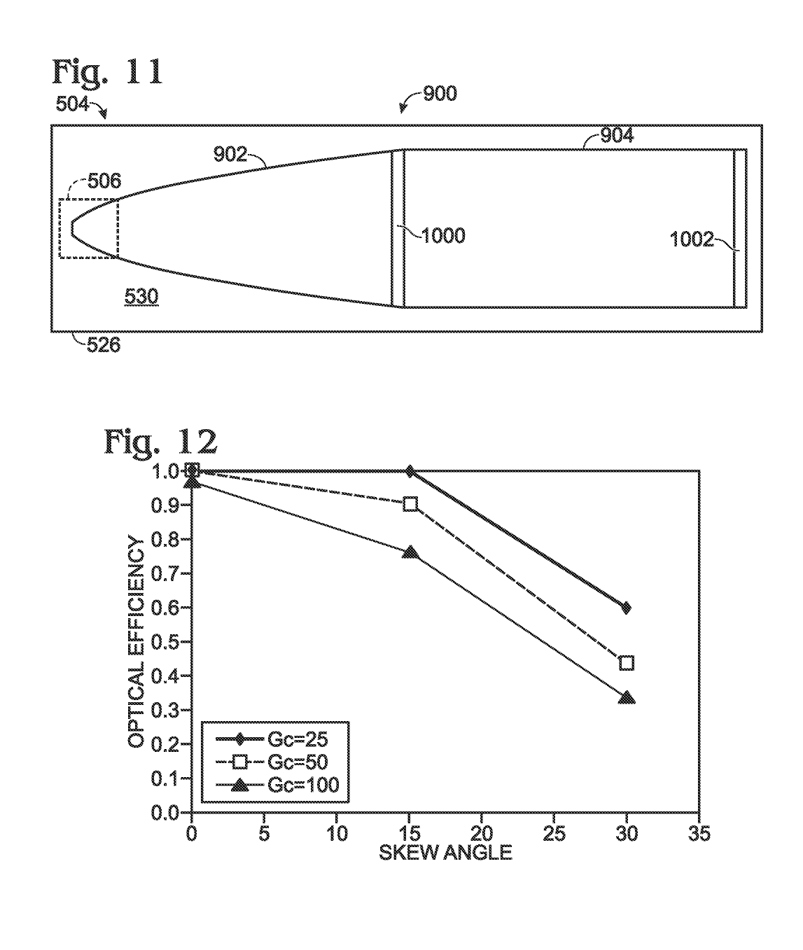

FIG. 11 is a plan view depicting the first, second, and fourth sheets of the system depicted in FIG. 9. The plurality of silicon PV cells 530 on the fourth sheet occupies a first surface area. To simplify the drawing, the first, second, and fourth sheets upon which the below-described components are mounted are not shown. For simplicity only a single PV cell 530 is shown occupying the entire rectangular shape representing the first surface. A plurality of CPV solar cell rows on the first sheet occupies a second surface area. For simplicity only the portion of row 504 is shown associated with a single CPV cell 506. A plurality of waveguide rows on the second sheet occupies a third surface area. For simplicity only a single waveguide comprising sections 902 and 904 is shown from row 900. The first surface area is greater than the summation of the second and third surface areas.

Returning to FIG. 8A, direct insolation may be collected by a highly transparent F/1 acylindrical glass lens, which focuses direct sunlight onto a molded acrylic waveguide 514. Further concentration in the lateral direction occurs as the waveguide conducts this light to high performance III-V cells 506. Advanced simulation (with Zemax software) indicates that an optical concentration of 500× or greater is achievable with this configuration. The III-V cells may be mounted directly on the end of the waveguide, but a more attractive alternative that saves wiring cost and enables rapid heat dissipation, is to silver the end of the waveguide to turn the light −45° to CPV cells mounted horizontally on top of a conventional 1-sun solar panel, which also collects diffuse radiation. This configuration enables a flat plate form factor and a reduction of panel thickness to less than 25 millimeters (mm). Moreover, lenses and waveguides are highly transparent, helping to reduce losses of diffuse radiation. In addition, the III-V cells are also quite small (0.7×0.7 mm), and therefore do not reduce the collection area of the 1-sun panel significantly. A 30% efficiency goal is achievable with this design. Both conventional 1-sun (e.g., c-Si) and III-V cells degrade less than 1% per year. Thus, total system degradation does not exceed 1%. To more effectively couple direct sunlight into the waveguide (i.e. achieve good optical efficiency) while maintaining a high geometric concentration of light into the CPV cells, a two-axis tracking system is employed, examples of which are described in Antonio L. Luque; Viacheslav M. Andreev, Concentrator Photovoltaics, 2007 Springer Verlag [14], which is incorporated herein by reference.

FIG. 12 shows the calculated optical efficiency for geometric concentrations of 25, 50, and 100 as a function of skew angle. The optical efficiency falls off rapidly with skew angle, especially for higher concentrations. If high concentration is required, this graph shows the need for tracking to reduce the skew angle incident on the lenses. Nevertheless, with tracking, highly efficient coupling can be achieved with compact F/1 optics.

A detailed loss and power model has been formulated and is summarized below. The major loss mechanisms are: Loss#1 and #2: the top lens plate, which even antireflective (AR) coated, induces 2% loss (1% for each surface). These losses occur for both direct and diffuse illumination.

Loss#3: For DNI light loss occurs when focused light is coupled into the waveguide; however, an optimized AR coating at the aperture can reduce this to 1%.

Loss#4: DNI light is reflected laterally by a silvered surface, which induces an additional 4% loss.

Loss#5: Likewise, there is a 4% loss upon exit of light from the waveguide to illuminate the CPV cells.

Loss#6: For diffuse light, there is transmission loss upon passing through the waveguides (even though they are transparent). This loss is 4% at entry and exit surfaces (8% total) although waveguides occupy only one quarter of the total area in some variations of the waveguide design. However, these losses could be reduced by coating of the waveguides.

Loss#7: Another diffuse loss is simply due to shadowing by silvered surfaces, which is about 5% of total 1-sun panel area.

Loss#8: Diffuse light at low angles becomes trapped in the acylindric lens by total internal reflection (TIR) with a collateral loss of about 21% for the worst-case scenario of a uniformly illuminated sky, as may occur on a day with thick clouds. Equivalent TIR loss in a Fresnel lens is only about 11%. For both acylindric and Fresnel lenses, the linear design of the top lens is subject to a lower loss than conventional pixelated 2D lenslet arrays.

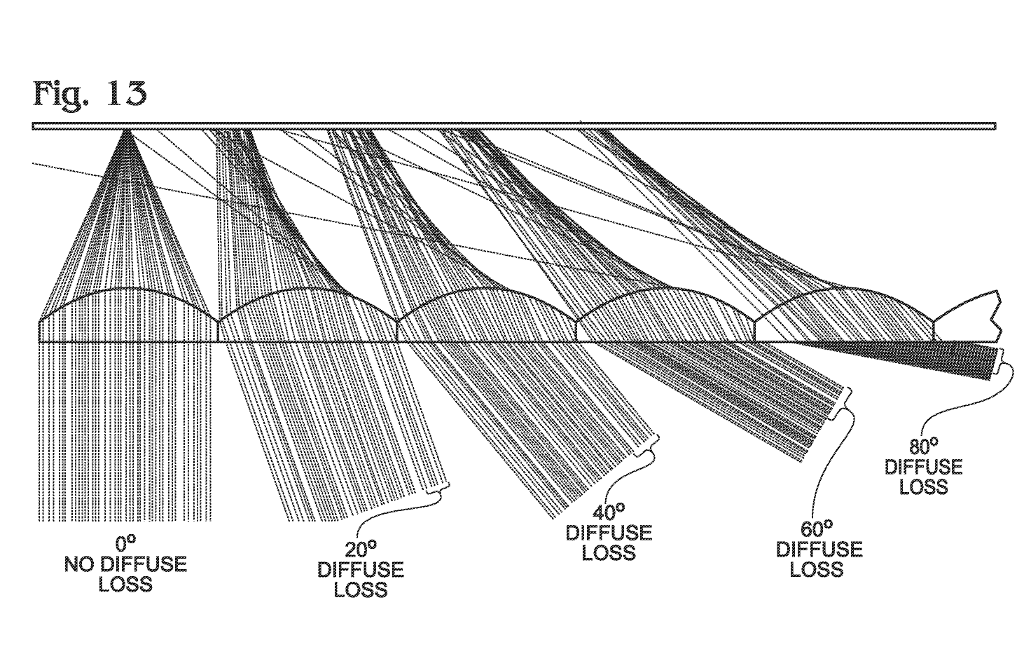

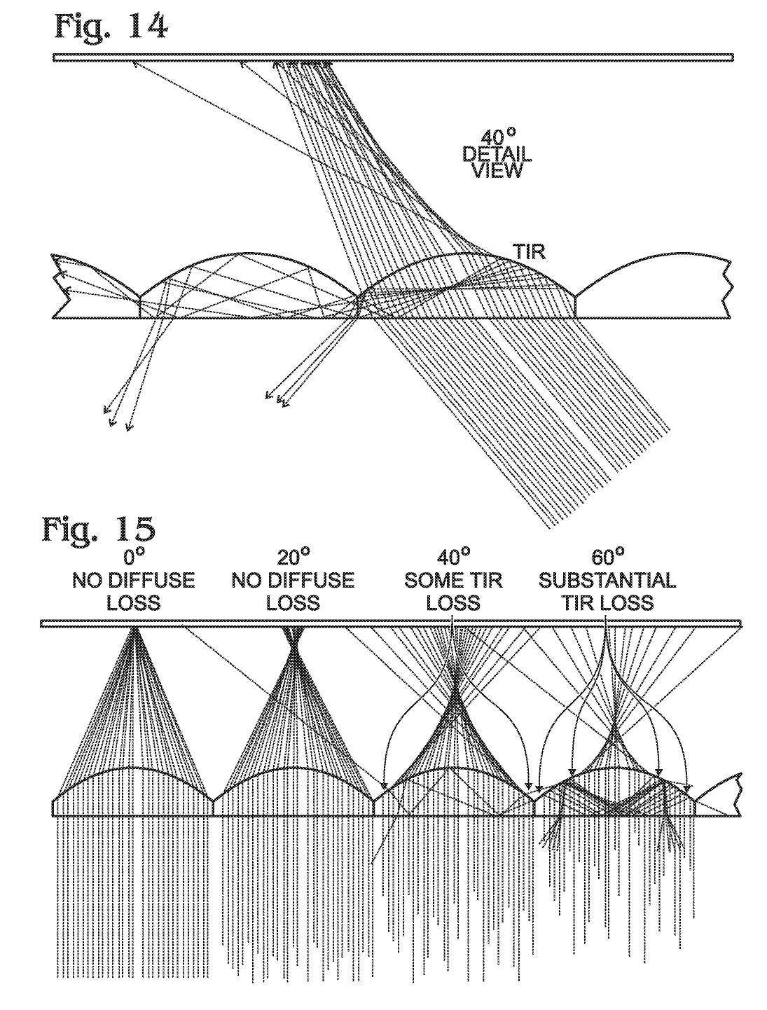

FIGS. 13-15 depict the final diffuse loss (#8). FIG. 13 is a simulation of diffuse loss as a function of incidence angle in the transverse plane of the lens array. FIG. 14 is a detailed view for a 40 degree incidence angle. FIG. 15 is a simulation of diffuse loss as a function of incidence angle in the axial plane of the lens array (i.e., along the length of the cylinder lenses).

This loss mechanism involves the trapping of diffuse light inside the cylindrical lens array from TIR. There is little loss within +/−20° of the normal direction to the lenses, but loss increases beyond that. Loss is less for diffuse light incident in the axial plane of the lenses (along the long direction of the cylinders), and more in the transverse plane. The simulations are for F/1 optics. These losses can be reduced with slower optics (i.e., a larger F/#). The amount of this loss depends on the character of the diffuse light. If the sun can be seen through high clouds, most of the light is within +/−20° and can be collected. If the sun cannot be seen at all due to thick clouds, this loss is high. However, in this latter case there is very little sunlight to be collected, so the absolute loss is not large.

TIR losses were further investigated by comparing linear arrays of acylindric lenses, unique to the systems described herein, and a conventional 2D lenslet arrays. These simulations are for F/1 and F/2 acylindric optics, but losses can be further reduced by using Fresnel lenses. Several assumptions were used in the simulations:

1) Worst-case scenario for diffuse sunlight: a diffuse sky which is uniformly bright.

2) Fresnel reflection and absorption losses are not included.

3) Only the geometric losses are calculated from TIR.

Transmission integrated over all incident angles is summarized for these four cases in the following table.

| Optical Array | F/1 | F/2 |
|---|---|---|
| Acylinder Array | 79.5% | 88.7% |
| 2D Lenslet Array | 72.3% | 84.5% |

It can be seen qualitatively that F/2 optics have a higher transmission than F/1 optics. It is further evident that a linear array of acylinder lenses is superior to a 2D array of lenslets in both cases. Nevertheless, worst-case, it is found that ˜20% of diffuse light is trapped inside a F/1 acylinder lens array. Even so, further simulations reveal that this can be reduced by about half using a linear array of Fresnel lenses, instead of acylinders.

Considering all these losses, a total optical efficiency for DNI light of 87.6% and for diffuse light of ˜85% is achievable. Therefore, the efficiency for AM1.5G (1000 W/m⁻²) depends on both PV cell efficiency and the diffuse/direct fraction. Current state-of-the-art III-V cell efficiency is about 46% at 1000×. Therefore, a CPV cell with efficiency between 40% and 44% is a reasonable. Likewise, current c-Si panel efficiencies are 21%.

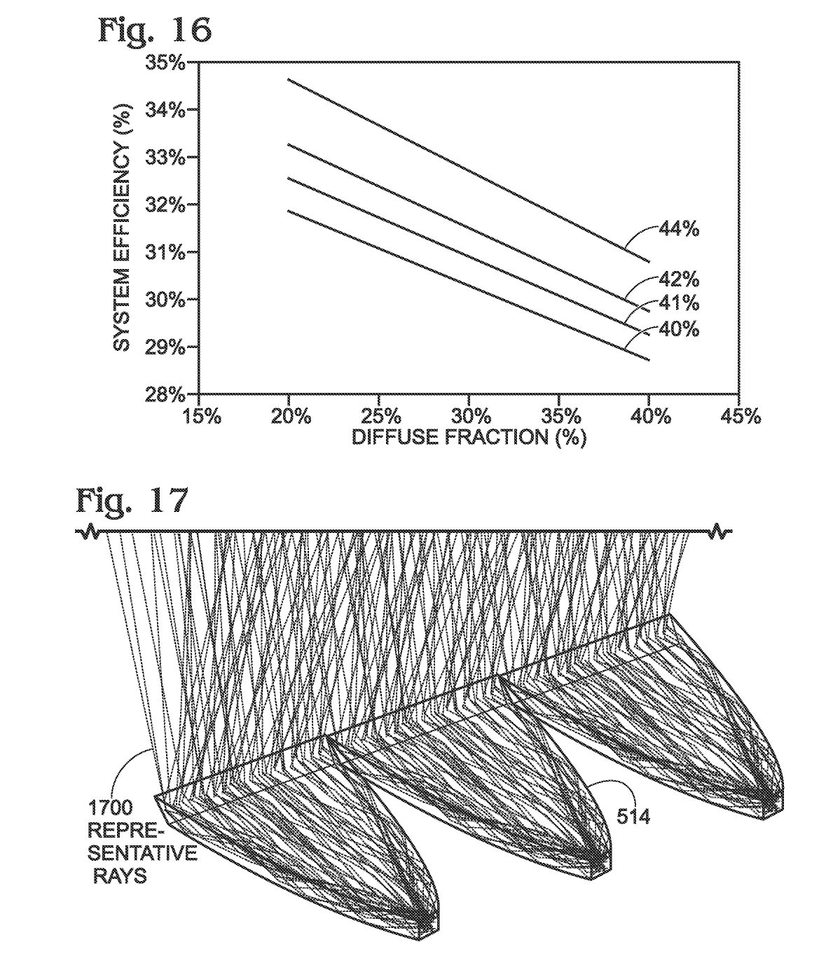

FIG. 16 is a graph illustrating the overall system efficiency as a function of CPV cell efficiency and diffuse light fraction. Diffuse light fraction is defined herein as being equal to diffuse/(diffuse+direct) light. Of course, CPV cell efficiency varies with concentration ratio (CR) and cell size. In general, cell efficiency increases with CR and reaches a maximum, which depends on cell size. In this case, a smaller cell has less of series resistance; hence better fill factor. This trend inverts if cell size is less than 0.5 mm, due to perimeter leakage. Therefore, cell dimensions are nominally assumed to 0.7×0.7 mm, with a calculated CR of 500×, very close to optimal conditions.

As always in solar power, achieving the lowest possible cost is of the highest importance. To enable a low cost, the modular assembly strategy presented herein substantially resembles manufacturing methods currently in use for production of LCD panels in which two layers of glass carrying complicated electrical and optical components are registered and assembled with high accuracy. Such methods enable long-inventors: term cost savings by improvement of manufacturing efficiency and economy-of-scale. Alternatively, in high DNI regions the 1-sun panels need not be included to achieve proposed system efficiency. In this case, long-term cost is reduced even further.

FIG. 17 is a perspective view depicting a row of waveguides with a tapered width in the shape of a compound parabolic concentrator (CPC). As is understood in the art, the sides of a CPC are parabolic mirrors with different focal points, and the CPC may accept light (representative rays 1700) at a relatively large angle with respect to the input aperture.

A flat panel PV system has been provided to effectively capture both high and low DNI. Examples of particular subcomponents and components layouts have been presented to illustrate the invention. However, the invention is not limited to merely these examples. Other variations and embodiments of the invention will occur to those skilled in the art.

We claim:

1. A flat panel photovoltaic (PV) system comprising:
a first sheet comprising a first row of concentrated III-V photovoltaic (CPV) solar cells, each CPV solar cell having an optical input and an electrical output;
a second sheet overlying the first sheet, the second sheet comprising a first row of waveguides, each waveguide having an optical input aperture, and optical output aperture coupled to a corresponding CPV solar cell optical input; and,
a third sheet overlying the second sheet, the third sheet comprising a one-piece linear lens overlying the first row of waveguides and having a focal line coupled to the optical input aperture of each waveguide in the first row of waveguides.

2. The flat panel PV system of claim 1 further comprising:
a fourth sheet underlying the first sheet, the fourth sheet comprising a 1-sun solar panel including a plurality of silicon PV cells.

3. The flat panel PV system of claim 1 wherein the second sheet further comprises a second row of waveguides, each waveguide in the second row of waveguides having an optical output aperture coupled to a corresponding CPV cell in the first row of CPV cells; and,
wherein the third sheet comprises a first one-piece linear lens overlying the first row of waveguides, a second one-piece linear lens overlying the second row of waveguides, with an intersection of the first and second one-piece linear lenses overlying the first row of CPV cells.

4. The flat panel PV system of claim 3 wherein the first sheet comprises a plurality of CPV solar cell rows; and,
wherein the first row of waveguides and second row of waveguides form a first waveguide assembly, and wherein the second sheet further comprises a plurality of waveguide assemblies, each waveguide assembly associated with a corresponding CPV solar cell row.

5. The flat panel PV system of claim 4 wherein each one-piece linear lens has a lens first width;
wherein adjacent waveguide assemblies in the second sheet are separated by a distance equal to the lens first width; and,
wherein each waveguide has a waveguide first length, between the optical input and optical output, equal to half the lens first width.

6. The flat panel PV system of claim 1 wherein the one-piece linear lens is selected from a group consisting of cylindric, acylindric, and Fresnel lenses.

7. The flat panel PV system of claim 1 wherein the second sheet layer further comprises a first mirror configured to redirect light from the focal line of the one-piece linear lens towards the optical output aperture of each waveguide in the first row of waveguides.

8. The flat panel PV system of claim 7 wherein each waveguide is transparent and has an optical input aperture formed in a planar top surface; and,
wherein the first mirror is positioned at a (−α) degree angle with respect to the planar top surface, where (α) is in a range of 30 to 60 degrees.

9. The flat panel PV system of claim 8 wherein each waveguide has an optical output aperture formed in a planar bottom surface of the waveguide; and,
the flat panel PV system further comprising:
a plurality of second mirrors, each second mirror is configured to redirect light through the waveguide output aperture and is positioned at a (−λ) degree angle with respect to the planar top surface of a corresponding waveguide, where λ is in a range of 30 to 60 degrees.

10. The flat panel PV system of claim 1 wherein the one-piece linear lens has an f-number in a range of F/0.5 to F/5.

11. The flat panel PV system of claim 2 wherein the plurality of silicon PV cells on the fourth sheet occupies a first surface area;
wherein a plurality of CPV solar cell rows on the first sheet occupies a second surface area;
wherein a plurality of waveguide rows on the second sheet occupies a third surface area; and,
wherein the first surface area is greater than the summation of the second and third surface areas.

12. The flat panel PV system of claim 1 wherein the one-piece linear lens has a focal line with a lens first length; and,
wherein each waveguide optical input aperture has a length formed in a planar waveguide top surface, and the summation of waveguide optical input aperture lengths in the first row of waveguides is equal to the first length.

13. The flat panel PV system of claim 1 wherein the second sheet further comprises a second row of waveguides, each waveguide in the second row of waveguides adjacent to a corresponding waveguide in the first row of waveguides, and having an optical output aperture coupled to an optical input aperture of the corresponding waveguide; and,
wherein the third sheet comprises a one-piece linear lens overlying each corresponding row of waveguides, with a focal line coupled to the optical input aperture of each waveguide in the corresponding row of waveguides.

14. The flat panel PV system of claim 1 wherein each waveguide in the first row of waveguides has a width tapered from the optical input aperture to the optical output aperture and selected from a group consisting of a straight edge and a compound parabolic concentrator (CPC) shape.

15. The flat panel PV system of claim 1 wherein the third sheet comprises a plurality of adjacent one-piece linear lenses, each one-piece linear lens having a first width;
wherein adjacent rows of waveguides in the second sheet are separated by a distance equal to the first width; and,
wherein each waveguide has a first length, between the optical input aperture and optical output aperture, less than the first width.

16. A flat panel photovoltaic (PV) system comprising:
a first sheet comprising a first row of concentrated III-V photovoltaic (CPV) solar cells, each CPV solar cell having an optical input and an electrical output;
a second sheet overlying the first sheet, the second sheet comprising a first row of waveguides, each waveguide having a first optical input aperture, a second optical input aperture, and optical output aperture coupled to a corresponding CPV solar cell optical input, with a first section between the first optical input aperture and optical output aperture and a second section between the second optical input aperture and the first optical input aperture; and,
a third sheet overlying the second sheet, the third sheet comprising a first one-piece linear lens overlying the first section, and having a first focal line coupled to the first optical input aperture of each waveguide in the first row of waveguides, and a second one-piece linear lens overlying the second section, and having a second focal line coupled to the second optical input aperture of each waveguide in the first row of waveguides.

17. The flat panel PV system of claim 16 further comprising:
a fourth sheet underlying the first sheet, the fourth sheet comprising a 1-sun solar panel including a plurality of silicon PV cells.

18. The flat panel PV system of claim 16 wherein each waveguide is transparent, with the first and second optical input apertures formed in a planar top surface, and the optical output aperture formed in a planar bottom surface;
wherein the second sheet layer further comprises:
a first mirror configured to redirect light from the first focal line of the first one-piece linear lens towards the optical output aperture of each waveguide in the first row of waveguides, where the first mirror is positioned at a −(α) degree angle with respect to the planar top surface, where (α) is in a range of 30 to 60 degrees;
a second mirror configured to redirect light from the second focal line of the second one-piece linear lens towards the optical output aperture of each waveguide in the first row of waveguides, where the second mirror is positioned at a −(Φ) degree angle with respect to the planar top surface, where (Φ) is in a range of 30 to 60 degrees; and,
a plurality of third mirrors, each third mirror positioned at a (−λ) degree angle with respect to the planar top surface and configured to redirect light through a corresponding waveguide optical output aperture to a corresponding CPV cell optical input, where λ is in a range of 30 to 60 degrees.

19. The flat panel PV system of claim 17 wherein the plurality of silicon PV cells on the fourth sheet occupies a first surface area;
wherein a plurality of CPV solar cell rows on the first sheet occupies a second surface area;
wherein a plurality of waveguide rows on the second sheet occupies a third surface area; and,
wherein the first surface area is greater than the summation of the second and third surface areas.

20. A flat panel photovoltaic (PV) system comprising:
a first sheet comprising a first row of concentrated III-V photovoltaic (CPV) solar cells, each CPV solar cell having an optical input and an electrical output;
a second sheet overlying the first sheet, the second sheet comprising a first row of waveguides and a second row of waveguides, each waveguide having an optical input aperture and an optical output aperture, with the optical output apertures of corresponding waveguides in the first and second row of waveguides paired to couple to a corresponding CPV solar cell optical input;
a third sheet overlying the second sheet, the third sheet comprising a one-piece linear lens overlying each row of waveguides, each one-piece lens having a focal line coupled to the optical input aperture of each waveguide in a corresponding row of waveguides, with an intersection of the first and second one-piece linear lenses overlying the first row of CPV cells; and,
a fourth sheet underlying the first sheet, the fourth sheet comprising a 1-sun solar panel including a plurality of silicon PV cells.

21. The flat panel PV system of claim 20 wherein the first sheet comprises a plurality of CPV solar cell rows; and,
wherein the first row of waveguides and second row of waveguides form a first waveguide assembly, and wherein the second sheet further comprises a plurality of waveguide assemblies, each waveguide assembly associated with a corresponding CPV solar cell row.
